(19) United States
(12) Patent Application Publication
(10) Pub. No.: US 2012/0238301 A1
(43) Pub. Date: Sep. 20, 2012

(54) SYSTEMS AND METHODS FOR NETWORKED RADIO SYSTEMS AND COORDINATED BROADCASTING

(75) Inventor: James Morrison, Las Vegas, NV (US)

(73) Assignee: SHIPSIN LLC, Las Vegas, NV (US)

(21) Appl. No.: 13/189,174

(22) Filed: Jul. 22, 2011

Related U.S. Application Data
(60) Provisional application No. 61/366,777, filed on Jul. 22, 2010.

(51) Int. Cl. H04W 88/00

(52) U.S. Cl. 455/500

(57) ABSTRACT

Systems and methods of creating a low power radio network which is networked to allow for a contiguous signal, which may be used to manage different devices, frequencies and content, are provided. Various antenna networks may be configured to focus on different areas using different communication spectrums, protocols, and the like. Different nodes in the system may be configured to transmit and/or receive similar or different information depending on expected or known consumer parameters, e.g. expected devices, rate/direction of travel, previously transmitted offers, etc. The variously described systems, controls and management modules may be used in ways that support detecting, tracking and communicating both unknown and known devices, so that, for example, if a consumer gets a FM message that prompts calling an IVR number, the system may acquire the consumer's mobile number and may assign business rules for future communication or detection.

### CROSS-REFERENCES TO RELATED APPLICATIONS

This application claims priority under 37 CFR §1.78(a) to U.S. Provisional Application Ser. No. 61/366,777 filed on Jul. 22, 2010, the contents of which are incorporated herein by reference in their entirety.

### BACKGROUND OF THE INVENTION

For years there has been a need for Radio Systems, e.g. Terrestrial, Satellite, or Personal Communication Devices such as mobile phones or computers, to reach as large a coverage or communication area as possible. FCC regulations mandate and regulate matters relating to broadcast power output, frequency, spectrum, placement of antennas and licensing of ‘stations’ or device configurations to allow communication with consumer radio devices.

With new radio communications protocols, such as BlueTooth, WiFi (802.11x, etc), 3, 4, 5G and beyond, AM, FM, RDS as well as microwave and satellite signals, communication with consumers has become a unique challenge to connect with a consumer at the right time, in the right place, with the information, service or content that the broadcaster desires to reach the consumer.

At any one time a person may be in their car with a Navigation System, a multi-band car radio (AM/FM/Sat), a mobile phone or even a computer. A half duplex communication system like the Navigation system may receive road, map and directional information, or the Radio System may collect news, sports, advertisements and can only receive information, and the full duplex communication systems like mobile phones or computers (if connected to a network) are the only two devices that can receive and transmit information, e.g. voice, data, content, etc. While Navigation Systems and In Car Electronic ‘Computer Systems’ become integrated, and as mobile phones become more connective to In Car systems, the need arises at a local level to be able to communicate with those devices and consumers.

### BRIEF SUMMARY OF THE INVENTION

The present subject matter generally provides systems and methods of creating a low power radio network which is networked to allow for a contiguous signal, which may be used to manage different devices, frequencies and content.

Ways in which antennas are configured and utilized allow them to focus on an area, and may provide for a coordinated ‘mesh’ of different communication spectrums, protocols, and the like. Thus, different nodes in the system may be configured to transmit/receive similar or different information depending on expected or known consumer parameters, e.g. expected devices, rate/direction of travel, previously transmitted offers, etc.

The variously described systems, controls and management modules may be used in ways that support detecting, tracking and communicating both unknown and known devices, so that, for example, if a consumer gets a FM message that prompts calling an IVR number, the system may acquire the consumer's mobile number and may assign business rules for future communication or detection. For instance if the system acquires a 100 BT address, and determines that the consumer arrives at a location, but never enters, that information may be helpful for businesses to help determine why not, or, if there are return customers, established by activity logs etc., that may also be helpful in determining whether to send the customer new offers rather than the same offer etc.

Similar methods may be employed with various communication devices and identification protocols, such as Bluetooth (BT) and Media Access Control (MAC).

According to embodiments, sensing or providing various protocols to communicate with devices in the network, e.g. BT, WiFi or other mobile communication devices such as mobile computers, in car electronics/Navigation etc., allows for a reach out capability, for example with a PING that establishes a request to connect with the device, where the PING itself may provide a message or opt-in/connect to this network message. The disclosed systems and methods allows further functionality over other known systems at least with respect to capturing device and consumer information for use over a wide area network, so that a mobile device/consumer may move or travel from coverage area to coverage area, and where the same device will be detected, tracked and communicated. Thus, according to embodiments, improved targeted communications, which may be modified over time, location, etc., may be extended over a range of the network, including areas with supporting system equipment. Advertisers may also be provided with improved access to consumers and feedback on advertising effectiveness.

According to further aspects of the invention, a system for interactively communicating with consumers may include one or more of a low power radio communication system configured to detect, track, and communicate with radio devices that include Mobile Communication Devices over multiple frequencies and communication protocols and an antenna system configured to include transmitters and receivers at different frequencies and power output stages where the transmission area can be focused or controlled, and transmissions to individual devices may be controlled according to location of the broadcast coverage area, an opt-in message or process received from the individual device and a location of the individual device. Embodiments may also include a broadcast control system which manages the broadcast and communication protocols and frequencies and coverage areas including at least two of AM, FM, BlueTooth, WiFi, Wimax, LTE, Mobile Spectrum, femtocell, and picocell networks.

According to further aspects of the invention, a broadcast management system may be provided that integrates all services and manages and controls the ‘best’ or preferred communication and connection methods for consumer devices in a broadcast area so that a communication link can be established to different classes of radio devices from AM-FM radio stations to determine the best detection, tracking and communication solution for different mobile devices where operating systems determine connection protocols, such as Apple iPhone® or iPad® devices, Research In Motion BlackBerry® devices, Google Android® devices, Palm WebOS devices, Java, BREW or other mobile communication devices where different generations (3G, 4G, 5G network) data communication devices are used to connect to radio networks.

According to further aspects of the invention, a system that detects, tracks and communicates with mobile devices may be provided in which an initial communication message is sent to the device to allow the consumer to opt-in or allow identification and to interact with the system, or that connects subsequently once the mobile device/consumer has opted in or allowed connection to the network, such as in response to a one-way transmission of opt-in information. The method of communication may include such communication protocols as Bluetooth, SMS, Network Detection, Wifi, or any other open or closed communication protocol including BTS or BSC radio systems depending on device or network access protocol or standards.

According to further aspects of the invention, a Wide(r) Area ‘system network’ may be provided that is comprised of different system broadcast coverage areas where a consumer may be detected and communicated with initially or in one area only to go out of coverage area for the system network only to enter another broadcast coverage area to be detected, tracked and communicated, and the system configured to keep a record of the ID so that as a mobile device or consumer moves into different coverage areas the system can detect, track and communicate with those devices and consumers.

According to further aspects of the invention, a detection system may be provided that determines ‘values or ID's’ to each user along with business rules that allow connectivity to the consumer such as mobile device identification parameters that are in the air such as MAC addresses, TMSI (temporary mobile subscriber ID) or MSI or telephone number, BlueTooth ID, or other ID parameter, and, from the mobile device identifier, the system may assign a ‘system or network ID’ unique to the system so that that the mobile device/consumer can be tracked and subsequently communicated with as they move to other system or network areas.

According to further aspects of the invention, a system may be provided that manages IDs, including various associated information including, for example, one or more of opt-in information, opt-out information and preferred or available methods of connection.

According to further aspects of the invention, a customer management system may be provided that connects consumer data such as MAC/BT/MIN (telephone number), PIN (RIM PIN), and creates a ‘enterprise’ like environment to allow communication and the delivery of information, offers, promotions and advertising based upon location, preferences, and/or analytical information or business rules to deliver the consumer a targeted message, offer or information, at a particular time and place, to a particular consumer/device, and over a particular radio connection channel to reach the device, dependent or independent of the standard or carrier network.

In embodiments, exemplary systems may be configured to detect those consumers that have responded to messages through their device ID when they arrive, pass by or enter a facility, for example, based on short range communication systems that register the presence of radio devices, etc.

In embodiments, a tracking and storage mechanism may be configured to develop analytics to provide the system the ability to build consumer profiles, such as by tracing movements, user acceptance of offers, users' physical movements after being sent an offer, user' purchases, users' purchases after receiving offers, etc.

In embodiments, a networking component may be provided that allows the signals to be synchronous, or independent, where an effective broadcast range is configured to a specific area or extended, while in compliance with government and/or industry standards and regulations.

According to further aspects of the invention, a radio communication system may be configured to detect, track, and communicate with a plurality of radio devices including mobile communication devices over multiple frequencies and communication protocols. Exemplary systems may include one or more of an antenna system including a plurality of transmitters and receivers having different frequencies, output power, and coverage area from one another; a device identification system configured to detect and track radio devices, including mobile communication devices over multiple frequencies and communication protocols, that communicate with said antenna system; and/or a broadcast control system configured to manage transmissions by said antenna system, including at least two of AM, FM, BlueTooth, WiFi, Wimax, LTE, Mobile Spectrum, femtocell, and picocell network transmissions, and to provide transmissions to at least one detected device based on at least one of a location of a broadcast coverage area, an opt-in message or process received from the detected device, and a location of the detected device.

In embodiments, the broadcast control system may be further configured to provide individualized transmissions to selected detected devices. The individualized transmissions may include, for example, advertizing information, which may be based on a number of factors, such as, a location of the detected device, a profile history associated with a user of the device, business rules associated with a user of the device, etc.

In embodiments, the broadcast control system may be further configured to provide individualized transmissions to a single selected detected device via AM, FM, BlueTooth, WiFi, Wimax, LTE, Mobile Spectrum, femtocell, and picocell networks. Embodiments may also include providing individualized transmissions to a single selected detected device via at least two of AM, FM, BlueTooth, WiFi, Wimax, LTE, Mobile Spectrum, femtocell, and picocell networks, or other combinations thereof. In embodiments, at least one of the networks may be selected based on a user selection received from the detected device or based on a preexisting user registration associated with the detected device.

In embodiments, the broadcast control system may be further configured to provide transmissions to a detected device from different antennas of the antenna system based on a detected or estimated rate of travel of the detected device.

In embodiments, the broadcast control system may be further configured to manage communication protocols, frequencies and/or coverage areas of transmissions by the antenna system.

In embodiments, the antenna system may include, for example, a plurality of low power radio communication transceivers, which may include one or more directional antennas with limited and specified coverage areas. In embodiments, a location of the detected device may be inferred from the coverage area of a transmitting or receiving network. For example, in cases where a user response or opt-in message is received including opt-in or other information that is transmitted to a limited, specified coverage area, the location of the user may be inferred to be within the coverage area of the transmission. Similarly, the location of a user may be inferred based on a user response received by a limited range LAN or other network.

In embodiments, the broadcast control system may be configured to manage transmissions to detected devices based on at least one of a location of a broadcast coverage area, an opt-in message or process received from the detected device, and a location of the detected device.

According to further aspects of the invention, a radio communication system as discussed herein may include one or more of a device identification system configured to identify individual radio devices, including mobile communication devices over multiple frequencies and communication protocols; and a broadcast control system configured to manage transmissions by a plurality of transmitter system, including one or more of AM, FM, BlueTooth, WiFi, Wimax, LTE, Mobile Spectrum, femtocell, and picocell networks, and to dynamically provide individualized transmissions to selected radio devices based on an acceptance message received from the selected radio devices.

In embodiments, an acceptance message may be received by the broadcast control system.

In embodiments, the device identification system may be further configured to identify individual radio devices based on the individual radio devices entering a specified area. The broadcast control system may be further configured to send an opt-in request to the individual radio devices based on the identification. In embodiments, the acceptance message may be received in response to the opt-in request.

In embodiments, the broadcast control system may be configured to broadcast an opt-in message including details for providing the acceptance message; the acceptance message may include at least one parameter from the opt-in message; and/or the device identification system may be further configured to identify individual radio devices based on the acceptance message.

In embodiments, a content of the individualized transmissions to selected radio devices may be based on user-related information such as, for example, at least one of business rules associated with a user, a location of an opt-in broadcast coverage area, a location of the selected radio devices, and/or other determined or inferred user location and/or preference information.

In embodiments, a device identification system may be configured to identify individual radio devices based on a unique ID; at least two supported networks may include different coverage areas; and/or said broadcast control system may be configured to change transmissions directed to the unique ID from a first network to a second supported network based on at least one of a connection failure over the first network and a detected and/or inferred change in location of the selected radio devices.

According to further aspects of the invention, a database may be provided including various information associated with users and/or devices such as, for example, unique IDs associated with radio devices, network information associated with the unique IDs, and/or a plurality of business rules associated with the unique IDs,

In embodiments, individualized transmissions to selected radio devices may be based on, for example, the network information associated with the unique IDs, and the plurality of business rules associated with the unique IDs.

In embodiments, the network information associated with a unique ID may include device identifiers and/or network addresses for a plurality of different networks.

In embodiments, the device identifiers and/or network addresses for the plurality of different networks may include, for example, various combinations of LAN address, WLAN address, e-mail address, mobile subscriber ID (MSI) temporary mobile subscriber ID (TMSI), telephone number, BlueTooth ID, and other user, device and/or network identifiers known in the art.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention claimed. The detailed description and the specific examples, however, indicate only preferred embodiments of the invention. Various changes and modifications within the spirit and scope of the invention will become apparent to those skilled in the art from this detailed description.

### BRIEF DESCRIPTION OF THE DRAWINGS

The accompanying drawings, which are included to provide a further understanding of the invention, are incorporated in and constitute a part of this specification, illustrate embodiments of the invention and together with the detailed description serve to explain the principles of the invention. No attempt is made to show structural details of the invention in more detail than may be necessary for a fundamental understanding of the invention and various ways in which it may be practiced. In the drawings:

FIG. 1 is a schematic illustration of an exemplary radio communication network according to aspects of the invention.

FIG. 2 is a schematic illustration showing additional details of an exemplary radio communication network according to aspects of the invention.

FIG. 3 is a graphic depiction of a database file with device-related information according to aspects of the invention.

FIG. 4 is a topographical depiction of a communication network in a local area which may be configured according to aspects of the invention.

FIG. 5 is a flow diagram including steps of an exemplary method according to aspects of the invention.

FIG. 6 is a schematic illustration of an exemplary network including network support, and communication, devices according to aspects of the invention.

### DETAILED DESCRIPTION OF THE INVENTION

It is understood that the invention is not limited to the particular methodology, protocols, and configurations, etc., described herein, as these may vary as the skilled artisan will recognize. It is also to be understood that the terminology used herein is used for the purpose of describing particular embodiments only, and is not intended to limit the scope of the invention. It also is be noted that as used herein and in the appended claims, the singular forms “a,” “an,” and “the” include the plural reference unless the context clearly dictates otherwise. Thus, for example, a reference to “a node” is a reference to one or more nodes and equivalents thereof known to those skilled in the art.

Unless defined otherwise, all technical and scientific terms used herein have the same meanings as commonly understood by one of ordinary skill in the art to which the invention pertains. The embodiments of the invention and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by the appended claims and applicable law. Moreover, it is noted that like reference numerals reference similar parts throughout the several views of the drawings.

Although various embodiments may be described in the context of particular radio communication networks and associated devices for clarity, the invention encompasses and may be applied to other networks and devices as will be appreciated by those of skill in the art. For example, in addition to the wireless radio communication methods described herein, other methods of communication, such as IR, or fully or partially wired networks, are also contemplated as falling within the scope of the invention.

It is known that, in the United States, the FCC is now allowing Low Power FM Broadcasts, with and without licensing, and there has been low power FM transmissions used for years for such things as drive in movie theaters, local area information at sports events for parking or directions, or even real estate signs that broadcast audio information to drivers passing by a home for sale. These radio applications, and systems broadcasting such data, require that the frequency used not interfere with licensed frequencies in the area, and comply with specific power output restrictions and antenna placement. Depending on the application, e.g. profit, non profit, school, etc, certain permissions and licenses must be granted and regulations adhered too.

The same applies for other radio interactions, e.g. WiFi, Bluetooth, satellite, mobile phones etc., where the need to connect with consumers in selected areas or locations require the installation of transmitters and receivers, to detect, track and communicate with devices, that comply with governmental and industry regulations.

Therefore, there is a need to comply with regulations while expanding coverage, and/or reach particular areas, to connect with as many consumers, listeners, viewers or subscribers as possible with as little infrastructure or ‘hardware’ as possible.

The systems and methods described herein, allow for a broadcaster to ‘reach’ out to consumers via radio devices, and allows for independent networks to communicate with consumer devices, such that the consumer may opt-in to a particular communication network to receive promotions, offers, advertisements, notifications, or other information that may be targeted based on device/consumer location, preferences, etc. According to embodiments, the prompt may be a ‘push’ notification to the consumer, rather than the consumer having to initiate the connection with such a service or network as in the case with SMS or current mobile communication systems which require the consumer to initiate the opt-in or connection process to find a network to connect with.

There may also be, for example, a linked communication pull/push where a consumer is prompted by a traditional radio system to call or initiate a connection with the network. However, embodiments of the invention may preferably provide a ‘push’ notification that sends a simple ‘ping’ message asking the consumer if they would like to communicate and connect to the network.

According to aspects of the invention, systems and methods may provide a way to configure low power radio systems in such a way as to allow for the broadcast of signals to a specific area to different classes of devices.

In embodiments, such systems may, in effect, create an integrated network of low power radio devices that are networked to allow for coverage over a larger area or a defined area where consumers would be detected, tracked and communicated with. The larger, or defined, area may be specifically designated through the creation of multi-frequency, multi-protocol, and/or multi-standard, radio broadcast systems, which may include directional antennas and the like. Such coverage may be designated to, for example, only send signals along a roadway or over a proximity to a store or event area.

In embodiments, the system may be networked to allow for the broadcast and communication protocol to allow for a continuous signal to be heard over a larger or networked area.

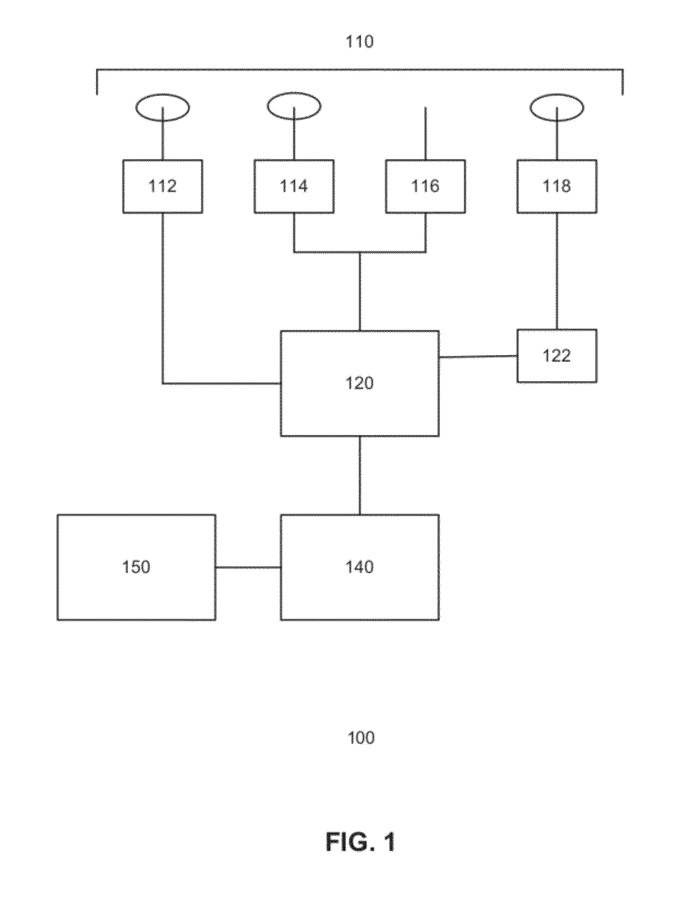

Exemplary systems may include a radio communication system configured to detect, track, and communicate with a plurality of radio devices including mobile communication devices over multiple frequencies and communication protocols. As schematically shown in FIG. 1, an exemplary communication system may include an antenna system 110 of various transmitters, receivers and transceivers, such as transceivers 112, 114, receiver 116 and transmitter 118. Transceivers 112, 114, may be, for example, network transceivers for different networks such as various cellular phone, BlueTooth, WiFi, Wimax, LTE, Mobile Spectrum, femtocell, and picocell networks. Receiver 116 may be, for example, a passive receiver configured to detect the presence of various transmitters, which may be associated with personal radio communication devices and the like, in a specified area. Transmitter 118 may be, for example, an AM or FM transmitter that is configured to broadcast information in a large or limited area. Thus, antenna system 110 may include a plurality of transmitters and receivers having different frequencies, output power, and coverage area from one another.

A device identification system 120 may be linked, directly or indirectly, to one or more of the transceivers 112, 114, receiver 116 and transmitter 118, included in antenna network 110. For example, device identification system 120 may be linked directly to transceiver 112, which may be at least partially subject to the control of device identification system 120. Alternatively, device identification system 120 may be linked indirectly to transmitter 118, which may be at least partially subject to the control of a transmitter control 122, such as a radio broadcast controller. Device identification system 120 may be configured to push “opt-in” or other message information to any of transceivers 112 and 114, or indirectly to transmitter 118 via transmitter control 122. Device identification system 120 may also be configured to receive device identification information from any of transceivers 112 and 114, or receiver 116. Device identification system 120 may also store and/or have access to coverage location information for any of transceivers 112 and 114, receiver 116, or transmitter 118.

In embodiments, device identification system 120 may be configured to detect and track radio devices, including mobile communication devices over multiple frequencies and communication protocols, that communicate with the antenna system 110. This may be done in a number of ways including, for example, logging and keeping track of individual device identifiers across different supported networks, referencing a database with different network and/or device information associated with a single user, referencing a database with different network information associated with a single device, etc.

A broadcast control system 140 may also be linked to the device identification system 120. Broadcast control system 140 may be configured to manage transmissions by the antenna system 110, including any supported network protocol, e.g. AM, FM, BlueTooth, WiFi, Wimax, LTE, Mobile Spectrum, femtocell, and picocell networks, etc. It should be understood that, unless otherwise specified, “networks” described herein may include two-way and/or one-way communication networks.

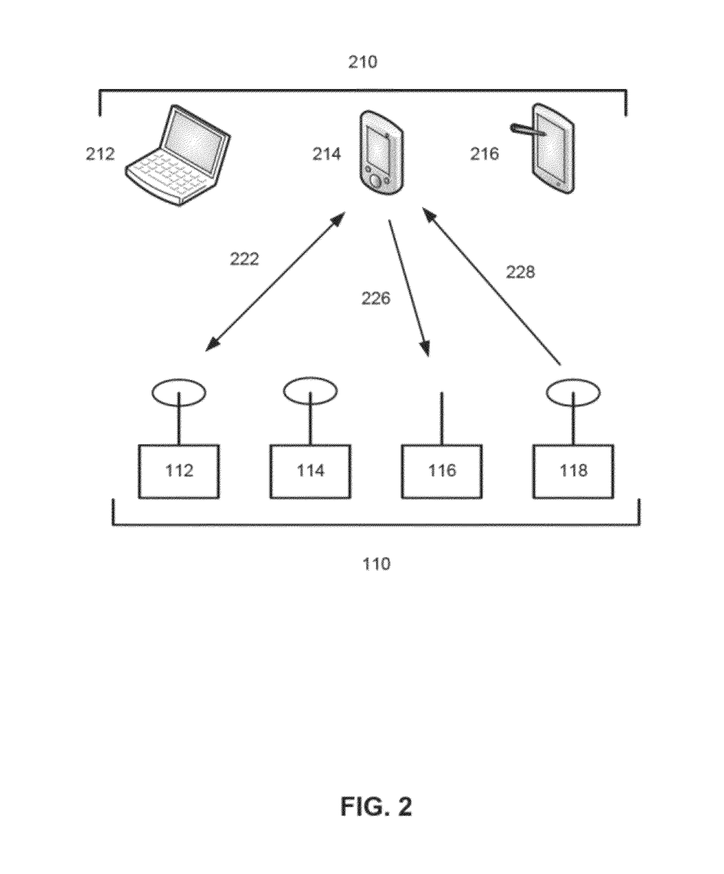

In embodiments, the broadcast control system 140 may be configured to provide individualized transmissions to selected detected devices. As described further herein, broadcast control system 140, and the like, may be configured to dynamically provide individualized transmissions to selected radio devices based on an acceptance message received from the selected radio devices. In embodiments, an acceptance message may be received by the broadcast control system 140, or other component of the system. Broadcast control system 140 may also or alternatively be configured to dynamically provide individualized transmissions to selected radio devices based on other information, such as location information, etc., if a user pre-registers with the system and, for example, pre-authorizes such transmissions. The individualized transmissions may include, for example, advertizing information, which may be based on a number of factors, such as, a location of the detected device, a profile history associated with a user of the device, business rules associated with a user of the device, etc. Further details of how the system may interact with individual user device and the like are shown in FIG. 2.

As shown in FIG. 2, a plurality of individual communication devices 210 may interact with the antenna network 110. Individual communication devices 210 may include, for example, laptop PC 212, smartphone 214, tablet PC 216, or other communication devices, such as pagers, car phones, navigation systems, etc. One or more of communication devices 210 may be associated with a user, e.g. a single user may register e-mail or other accounts accessible via laptop PC, along with phone numbers etc. registered with smartphone 214. Likewise, an individual communication device may be supported by multiple antennas in antenna system 110, such as smartphone 214 configured to transceive network communication 222 with transceiver 112, transmit signals 226 that are received by receiver 116, and/or receive broadcast signal 228, such as FM or AM radio broadcasts, from transmitter 118.

As described further herein, broadcast control system 140, shown in FIG. 1, may be configured to provide transmissions to any of devices 210 detected by device identification system 120 based on, for example, a location of a broadcast coverage area related to transceiver 112, 114 and/or transmitter 228, and/or an estimated detection range of receiver 116. It should be noted that, although the “receiving range” of a passive receiver may be dependent on signal strength, there are relevant parameters known in the art that may allow a reasonable estimation of the proximate location of the device 210. For example, WiFi, or other networks, may typically be supported by transmissions in an allowable range. Therefore, a passively detected WiFi transmission from, e.g. laptop computer 212, may suggest an approximate location of the device. Other location information may be more precisely determined by other methods known in the art, such as using GPS technology which may be included in devices 210, etc.

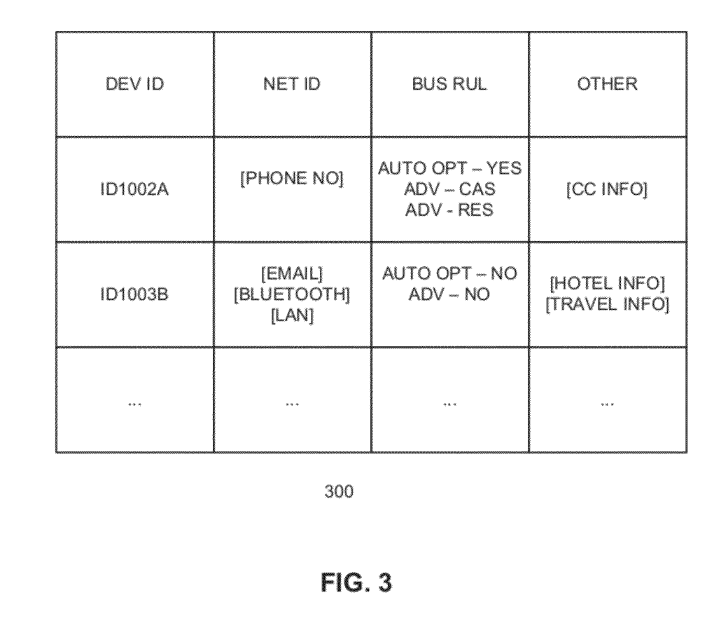

By way of further example, location information, and other information related to users and devices described herein, may be obtained from alternative sources, such as support center 150 shown in FIG. 1. Support center 150 may include information related to, for example, credit card usage by a consumer, travel and/or hotel information related to a consumer, etc. Broadcast control system 140 may store, or have access to, information that links individual consumers with network device and/or address information, e.g. email address, phone number, network addresses, etc. Thus, various individualized messages may be directed to users' addresses and/or devices using the combination of such information as may be obtained from myriad sources. Typically, a user must provide at least some level of permission for such information to be assembled. However, portions of such information may also be publically available, e.g. phone books etc., and may be assembled by support services with or without user consent. An example of a database record that may be stored by broadcast control system 140 or the like is shown in FIG. 3.

As graphically shown in FIG. 3, a database record 300 may include various fields, such as device ID “DEV ID”, network ID “NET ID”, business rules “BUS RUL” and/or other information “OTHER.” The database record 300 may be associated with a single user, e.g. via a separate user ID, or may apply to various users. In the embodiment shown in FIG. 3, an individual user may have multiple devices ID1002A, ID1003B with their own assigned “DEV ID”, “NET ID”, “BUS RUL” and “OTHER” parameters. Individual devices may have one or more pieces of information in each of the identified fields, e.g. device ID1003B may have multiple network identifiers associated with it such as email address, a Bluetooth ID, and a LAN ID, whereas device ID1002A may have only a single phone number associated with it. Accordingly, exemplary systems may support messages in different protocols, networks, etc. to a single device and/or user, e.g. by referencing a set of stored information such as shown in FIG. 3.

Various business rules, which may be set by the user, may also be associated with the user or with individual devices. For example, a user may set a rule to automatically opt-in to an advertising or other network when the device is detected (“AUTO OPT—YES”) or may set a rule not to automatically opt-in to the network when the device is detected (“AUTO OPT—NO”). Various adverting or other types of desired information may also be set in the business rules, e.g. casino advertising (“ADV—CAS”), restaurant advertising (“ADV—RES”), etc., or the user may opt-out of receiving any advertising (“ADV—NO”). Myriad other option and sub options may be set depending on the desired information.

Additional information related to the user or device may be provided, for example, in an “OTHER” field. For example, credit card identification information (“CC INFO”), hotel information related to where the user is staying or the device is detected (“HOTEL INFO”), travel information provided by the user, or developed over time by tracking the device (“TRAVEL INFO”), may be stored in association with a user or device ID.

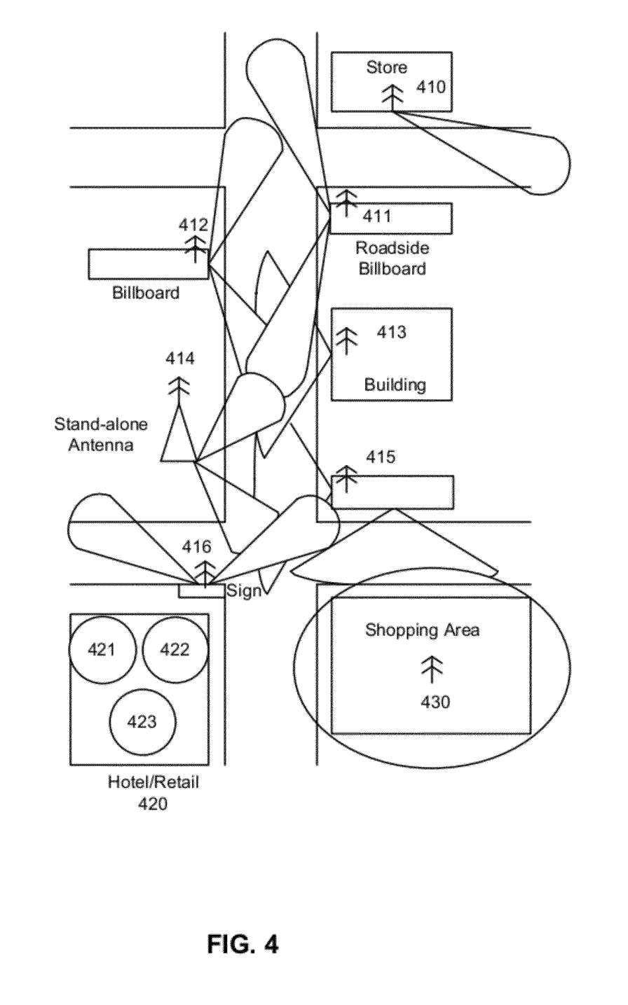

Aspects of the invention may be accomplished, for example, by using directional antenna(s) that may direct the signals used to connect to a broadcaster or broadcasters and set the frequencies required to communicate with a plurality of devices. There may be AM, FM, WiFi, BlueTooth etc. in one or more antenna set(s) that are communicating with a central network that is timing the signals being broadcast to create a seamless content listening experience or to hand off signals to allow for a fully interactive broadcast and response such as with a mobile phone Bluetooth, WiFi or other bidirectional communication system. Further details of an exemplary system as applied to a local area are shown in FIG. 4.

As shown in FIG. 4, an exemplary system may include a plurality of antennas in a given area, as shown on the map. Antenna 410 shows an antenna broadcasting its own signal and content independently of the other antennas in the figure, e.g. a business could set up a low power communication system that would allow them to communicate with consumers approaching their place of business from a particular direction.

A unique factor of using low power radio systems is that, if that antenna was to be a radial dispersive antenna, the radio output range would not allow them to communicate or ‘connect’ with the consumer as they approach in time to allow the consumer to respond or act upon the received broadcast. Therefore, directional antennas, such as a Yagi antenna, may be employed to provide low-power broadcasts with sufficient directional range to ‘connect’ with consumers in sufficient time to act.

Antennas 411-416 represent a set of focus array antennas, which may be configured to address different systems, e.g. AM/FM/Bluetooth, WiFi, Cellular, etc. The antennas may be configured in such a manner to focus their broadcast areas over a specific area, or in the depicted example a roadway.

In embodiments, such as those using an FM transmission, a continuous loop playing content may be played to the consumer on a specific frequency that may be, for example, displayed on a roadside sign that reads “TUNE TO (FREQ) FM FOR FREE OFFERS AND PROMOTIONS”. Once tuned in, the consumer may be presented with offers or other calls to action, such as to call an 800 IVR number, text a sweepstakes code, or opt in to get more offers for an hour or day.

A unique aspect of the systems and methods is that the signal may be contiguous, or substantially contiguous in a desired and/or specifically tailored area, while being compliant with applicable laws regarding broadcast signal strength, configuration and the like. Thus, content and broadcast parameters may be specifically tailored for a given area, e.g. an estimated speed and time on a particular length of roadway may be used to calculate a desirable broadcast loop time, such as a 7 minute loop over 12 miles at 60 mph.

Thus, in situations where one or more antennas such as antennas 411-416 have a localized coverage area, such as shown in the cones in FIG. 4, a location of the detected device may be inferred from the coverage area of a transmitting or receiving network associated with the antenna or antennas. For example, in cases where a user response or opt-in message is received including opt-in or other information that is transmitted to the coverage area of antenna 416 or the like, the location of the user may be inferred to be within the coverage area of that transmission. Similarly, the location of a user may be inferred to be within Hotel/Retail area 420 based on a user response received by a limited range LAN or other network, such as represented by antennas 421-423.

Additional benefits may include the ability to reach out to consumer devices that have an open communication channel, such as BlueTooth or WiFi, where the signal range needs to be extended in order to establish or maintain a connection in order to deliver the required content. For example, antennas 415, 413 may be set up with a networked (daisy chain) set of Bluetooth radios and/or WiFi radios. Static displays, such as roadside signs, posters, etc., may also be used to provide related instructions, such as “Turn on your BlueTooth or launch your browser now.”

An exemplary method may use a communication link, such as Bluetooth, as follows. As consumers enter into the area with appropriate coverage, the consumer may automatically be prompted with a preliminary message that appears and is presented like a ‘pairing message’ that may suggest benefits and actions, such as “Would you like FREE FOOD, OFFERS OR TO RECEIVE OFFERS WHILE YOU ARE IN ‘LAS VEGAS’ Press OK to opt in.” Connection to the desired network is thus made easier for the consumer, and may also provide important information for the consumer to use in making the decision whether to “opt in.” Coordinated network communication may allow, for example, a consumer to travel past two, or more, signs or broadcast locations before the responding to an offer and to connect subsequently to other network devices that will recognize the consumer and deliver messages to them automatically.

If the consumer opts in, the system may acquire a specific device ID from the device, which can then be used to track the device, log activities, and/or provide future or other messages in the session. This may include opening up a connection to deliver a streaming information message with audio, video or multimedia as well as delivering test, multimedia or graphical based messages with coupons, offers in promotional information.

In multi-platform systems, if the consumer chooses not to opt in for BT, they can still opt in for offers by other means, for example, from the FM call to action to call an IVR, or text in or use WiFi to opt in or receive other messages.

According to embodiments, WiFi or other connectivity may also be coordinated in designated areas, for example, so that when a consumer is prompted to launch a browser they will be directed to a webpage the network controls and presents offers to opt in for offers, look at offers, and other information. If the consumer opts in, the system may acquire a MAC address, and the like, from the user's device, and therefore can track and communicate with the consumer at other locations, as they travel into areas networked into the system. Such communications may be targeted based on the location of the user device.

For example, once a device has been opted in, the consumer may be directed to various different locations, e.g. retail locations, service stations, restaurants, hotels, casinos, etc., though the use of promotional offers, etc. By using one or more coordinated bi-directional networks, such as a user device communicating with antennas 413, 415 and/or 421-423 listed in different buildings, the system can communicate with the consumer and also track the consumer in a meaningful way, such as when they arrive at, or leave, a specific location. In embodiments, this may include referencing different networks, or a similar network, communication.

Such information may be determined and used to target communications to the user, for example, when a consumer arrives and passes 413 they again could receive a targeted offer or other communication relevant to the location. Embodiments may also include logs that record the user's activity, which may be linked to promotional offers and the like that have been provided to the consumer by the network. For example, with respect to an antenna at a particular location, it may be determined if a consumer has entered the business area, walked by the area, or didn't show up in the area at all. Thus, advertising revenue may also be generated based on actual consumer activity linked to the system. That is, systems may log when a user gets a particular advertisement and where they went after that, demonstrating that the advertisement was or was not effective in getting the consumer's attention.

By way of further example, a Master Offer may be transmitted to go to a particular retail location. Once there, the network can then ‘sell’ access to the consumer to the businesses in that area, such as by allowing that business to communicate with the consumer knowing they came in off the Radio System ‘system’.

In embodiments, systems may also support those consumers that have not arrived from the Radio System, but that otherwise indicate that they want to receive messages. In such cases, the local area antennas may operate similarly to the Highway Radio System to acquire, and communicate with, customers, still allowing for the consumer to become part of the system database, after being registered.

In embodiments, systems and methods may further support different businesses with different promotions running using a coordinated network. In such cases, different business may have different access and support services. Such systems may be further configured to allow the consumer to control which offers they receive.

As depicted in FIG. 4, an antenna 430 may be associated with a different facility than the rest of the antennas. The support provided to the particular facility by the system and antenna 430 may be different than the rest of the networks' antennas, such as, for example, Antenna 430 may not be driven from the highway radio system, the facility/business may not be provided access to system logs and other consumer data, etc.

Additionally, the system may support functions where a consumer may opt-in or otherwise interact with the system with respect to a specific retailer and the like, and the consumer may indicate a desire to be connected each time they are near a same or similar retailer and the like. Additionally, a particular location, such as a mall, hotel and the like, may control rights to a data base associated with the location and may selectively share that information or access with their tenants, other locations, retailers and the like.

As mentioned previously, exemplary systems may be configured to identify individual radio devices and/or users based on a unique ID. Systems may also be configured to change transmissions directed to the unique ID from a first network to a second supported network based on, for example, a connection failure over the first network or a detected and/or inferred change in location of the selected radio devices. For example, a user communication with antenna 416 may be interrupted. The system may have information suggesting that the user may be relocating to another location, e.g. based on an offer provided to the user. Subsequently, communication with the user could be reinitiated on a similar or different network at the expected location, e.g. the WiFi 421-423 in Hotel/Retail location 410. The system may be further configured to provide rewards to the user if this communication is successful, e.g. indicting that the user has accepted to offer to enter Hotel/Retail location 410. Further, based on a change location, the system may automatically change a network, address, device, or other parameter for a subsequent message to the user based on the change in location, e.g. a text message may be sent to the user when they leave a specified network coverage area, etc.

In embodiments, a user or device profile stored by the system may include parameters that prompt tailored messages to the user device based on location. For example, assuming the building with antenna 415 has an Italian restaurant, and the user has previously indicated that they desire to receive “Italian restaurant” advertising, when the user device is in communication with antenna 415, an automated advertising message may be sent to the user, e.g. with the restaurant name and location, and any other promotional offers, which may be time and/or location based.

It should be appreciated that a system such as shown in FIG. 4 is equally applicable to alternative communication systems, e.g. car phone (which may be linked to navigation systems), a multi-band car radio (AM/FM/Sat), pagers, etc. The inventors have contemplated, for example, implementations integrating half duplex communication system like a navigation system that may receive road, map and directional information, or a radio system that may collect news, sports, advertisements but can only receive information, with full duplex communication systems like mobile phones or computers (if connected to a network) that can receive and transmit information, e.g. voice, data, content, etc.

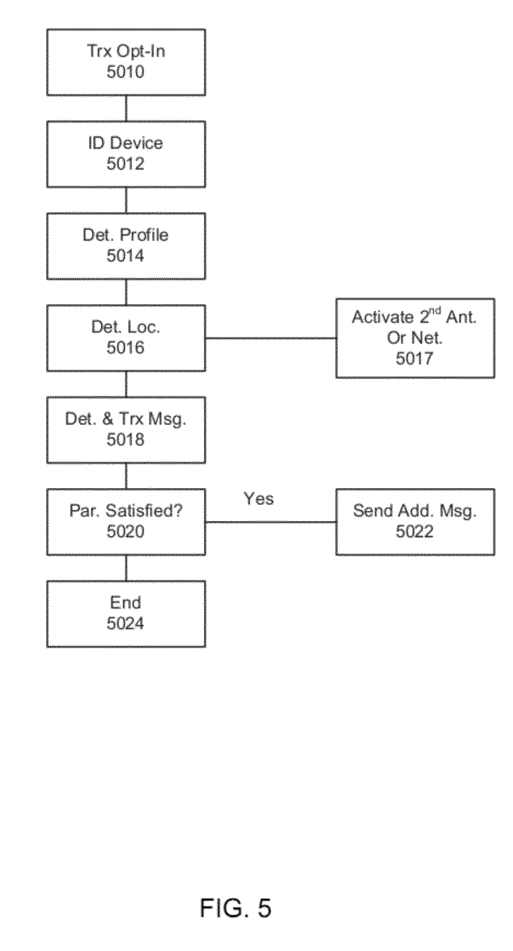

As will be appreciated by those of skill in the art upon understanding the content of this disclosure, methods of providing the services described herein are also encompassed by the invention. For example, a method of providing dynamic communications with individual devices is described with reference to FIG. 5.

As shown in FIG. 5, a method may begin with an optional step 5010 of transmitting a one-way opt-in message. The method may continue with step 5012.

In step 5012, the method may continue with identifying a specific device. Devices may be identified by various methods described herein, and may include, for example, acquiring device ID information via a communication network, accepting user ID information as part of an accept message, etc. The method may continue with step 5014.

In step 5014, the system may determine whether a user and/or device profile exists for the device identified in step 5012. This may include referencing databases as described herein and the like. The method may continue with step 5016.

In step 5016, the system may determine a location of the device. This may include referencing coverage location information related to, for example, transceivers, receivers, and/or transmitters, or may be derived from the device or user/device profile, as described herein, and the like. Step 5016 may be understood as continuing throughout communication with the device and may include tracking the movement of the device, recognizing changes in location, etc. Based on changes in location, and/or other parameters, the method may continue with step 5019 in which a different network or antenna in a similar network may be activated to communicate with the device. The method may continue with step 5018.

In step 5018, the system may determine a tailored message to the user/device based on, for example, any of the foregoing accumulated information, such as location, change in location, business rules, etc. This may include referencing databases as described herein and the like. The message may be directed and transmitted to the user/device in various ways described herein and the like. The method may continue with step 5020.

In step 5020, the system may determine whether a parameter of the tailored message to the user/device has been satisfied. This may be based on, for example, change in location, communication with a different network or antenna, a purchase at a given location, etc. If the parameter of the tailored message is satisfied, additional processing may be performed in step 5022, such as, for example, transmission of an additional message to the user (which may include additional promotions or rewards), a transmission to an interested third party, billing an advertiser's account, etc.

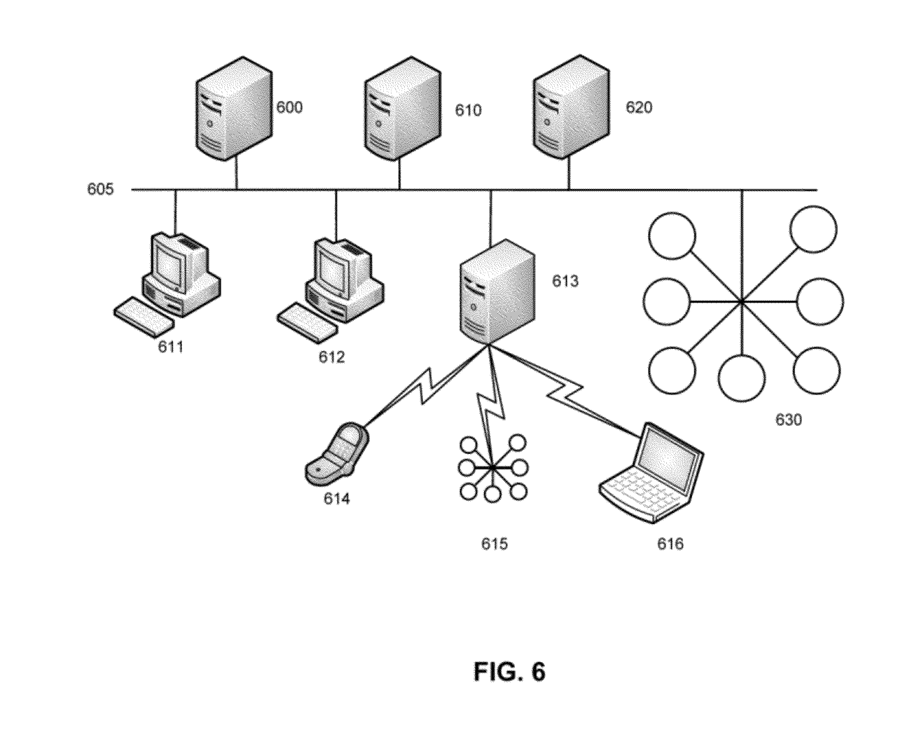

Embodiments of the present invention can include systems for implementing the described methods, as well as computer-readable storage medium coded with instructions for causing a computer to execute the described methods. For example, as shown in FIG. 6, server systems such as servers 600, 610, and/or 620, including at least a processor, a memory and an electronic communication device (not shown), may be configured to receive, identify, respond to and/or act on communications, such as those described herein, received over the network 605, such as the Internet.

Communications may originate from, for example, a user, a service provider, etc, via various systems such as, for example, computers 611, 612, via separate server 613 which may be in wireless or other communication with mobile device(s) 614, picocell network devices 615, mobile computer 616, or any other network-capable device with the requisite functional capabilities.

The various communications, transmissions, and related functions described herein may be accomplished, for example, via the network 605, and the results of the described processing performed by server systems such as servers 600, 610 and 620, may be displayed, stored and/or distributed according to known techniques. The network 605 may include any number of communication components including wired, cellular, satellite, optical and/or other similar communication links.

The servers 600, 610 and 620, and computers 611, 612, may include any number of processors (not shown) that are coupled to storage devices including a first storage (not shown, typically a random access memory, or “RAM”), second storage (not shown, typically a read only memory, or “ROM”). Both of these storage devices may include any suitable type of computer-readable media, including non-transitory storage media such as flash drives, hard disks, floppy disks, magnetic tape, optical media such as CD-ROM disks, and/or magneto-optical media such as floptical disks. A mass storage device (not shown) may also be used to store programs, data and the like and is typically a secondary storage medium, such as a hard disk that is slower than primary storage. It will be appreciated that the information retained within the mass storage device, may, in appropriate cases, be incorporated in standard manner as part of primary storage as virtual memory. A specific mass storage device such as a CD-ROM may also pass data uni-directionally to the processor.

The servers 600, 610 and 620, and computers 611, 612, may also include an interface that includes one or more input/output devices such as such as video monitors, track balls, mice, keyboards, microphones, touch-sensitive displays, transducer card readers, magnetic or paper tape readers, tablets, styluses, voice or handwriting recognizers, or other known input devices, including other computers. The servers 600, 610 and 620, and computers 611, 612, may be coupled to a computer or other electronic communication network 605 using a network connection. The network 605 can connect various wired, optical, electronic and other known networks to exchange information among servers 600, 610 and 620, computers 611, 612, separate server 613, mobile device(s) 614, picocell network devices 615, mobile computer(s) 616, recursive servers 630, and any other devices with similar functionality. With such a network connection, it is contemplated that the servers 600, 610 and 620, and computers 611, 612 and the processors therein may receive information from the network 605, or may output information to the network 605 in the course of performing the above-described method steps. The above-described devices and materials will be familiar to those of skill in the computer hardware and software arts and need not be individually or exhaustively depicted to be understood by those of skill in the art. The hardware elements described above may be configured (usually temporarily) to act as one or more modules for performing the operations described above.

In addition, embodiments of the present invention further include computer-readable storage media that include program instructions for performing various computer-implemented operations as described herein. The media may also include, alone or in combination with the program instructions, data files, data structures, tables, and the like. The media and program instructions may be those specially designed and constructed for the purposes of the present subject matter, or they may be of the kind available to those having skill in the computer software arts. Examples of computer-readable storage media include magnetic media such as flash drives, hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter.

The description given above is merely illustrative and is not meant to be an exhaustive list of all possible embodiments, applications or modifications of the invention. Thus, various modifications and variations of the described methods and systems of the invention will be apparent to those skilled in the art without departing from the scope and spirit of the invention. Although the invention has been described in connection with specific embodiments, it should be understood that the invention as claimed should not be unduly limited to such specific embodiments. Indeed, various modifications of the described modes for carrying out the invention which are obvious to those skilled in the communication network design, communication network manufacture or related fields are intended to be within the scope of the appended claims.

What is claimed is:

1. A radio communication system configured to detect, track, and communicate with a plurality of radio devices including mobile communication devices over multiple frequencies and communication protocols, said system comprising:
an antenna system including a plurality of transmitters and receivers having different frequencies, output power, and coverage area from one another;
a device identification system configured to detect and track radio devices, including mobile communication devices over multiple frequencies and communication protocols, that communicate with said antenna system; and
a broadcast control system configured to manage transmissions by said antenna system, including at least two of AM, FM, BlueTooth, WiFi, Wimax, LTE, Mobile Spectrum, femtocell, and picocell network transmissions, and to provide transmissions to at least one detected device based on at least one of a location of a broadcast coverage area, an opt-in message or process received from the detected device, and a location of the detected device.

2. The system of claim 1, wherein said broadcast control system is further configured to provide individualized transmissions to selected detected devices.

3. The system of claim 2, wherein the individualized transmissions include advertizing information based on a location of the detected device.

4. The system of claim 2, wherein said broadcast control system is further configured to provide individualized transmissions to a single selected detected device via at least two of AM, FM, BlueTooth, WiFi, Wimax, LTE, Mobile Spectrum, femtocell, and picocell networks.

5. The system of claim 4, wherein at least one of the networks are selected based on a user selection.

6. The system of claim 5, wherein the user selection is received from the detected device or based on a preexisting user registration associated with the detected device.

7. The system of claim 1, wherein said broadcast control system is further configured to provide transmissions to a detected device from different antennas of said antenna system based on a detected or estimated rate of travel of the detected device.

8. The system of claim 1, wherein said broadcast control system is further configured to manage communication protocols, frequencies and coverage areas of transmissions by said antenna system.

9. The system of claim 1, wherein said antenna system comprises a plurality of low power radio communication transceivers, including at least one directional antenna. a broadcast control system configured to manage transmissions

10. The system of claim 1, wherein said broadcast control system is further configured to manage transmissions to detected devices based on at least one of a location of a broadcast coverage area, an opt-in message or process received from the detected device, and a location of the detected device.

11. A radio communication system configured to detect, track, and communicate with a plurality of radio devices including mobile communication devices over multiple frequencies and communication protocols, said system comprising:
a device identification system configured to identify individual radio devices, including mobile communication devices over multiple frequencies and communication protocols; and
a broadcast control system configured to manage transmissions by a plurality of transmitter system, including at least two of AM, FM, BlueTooth, WiFi, Wimax, LTE, Mobile Spectrum, femtocell, and picocell networks, and to dynamically provide individualized transmissions to selected radio devices based on an acceptance message received from the selected radio devices.

12. The system of claim 11, wherein the acceptance message is received by the broadcast control system.

13. The system of claim 11, wherein:
said device identification system is further configured to identify individual radio devices based on the individual radio devices entering a specified area;
the broadcast control system is further configured to send an opt-in request to the individual radio devices based on the identification; and
the acceptance message is received in response to the opt-in request.

14. The system of claim 11, wherein:
said broadcast control system is configured to broadcast an opt-in message including details for providing the acceptance message;
the acceptance message includes at least one parameter from the opt-in message; and
said device identification system is further configured to identify individual radio devices based on the acceptance message.

15. The system of claim 11, wherein a content of the individualized transmissions to selected radio devices are further based on at least one of a location of an opt-in broadcast coverage area and a location of the selected radio devices.

16. The system of claim 11, wherein a content of the individualized transmissions to selected radio devices are further based on an opt-in broadcast coverage area.

17. The system of claim 11, wherein a content of the individualized transmissions to selected radio devices are further based on a location of the selected radio devices.

18. The system of claim 11, wherein:
said device identification system is further configured to identify individual radio devices based on a unique ID;
the at least two of AM, FM, BlueTooth, WiFi, Wimax, LTE, Mobile Spectrum, femtocell, and picocell networks, include different coverage areas; and
said broadcast control system is further configured to change transmissions directed to the unique ID from a first network to a second network based on at least one of a connection failure over the first network and a change in location of the selected radio devices.

19. The system of claim 11, further comprising:
a database including (a) unique IDs associated with radio devices, (b) network information associated with the unique IDs, and (c) a plurality of business rules associated with the unique IDs,
wherein the individualized transmissions to selected radio devices are based on the network information associated with the unique IDs, and the plurality of business rules associated with the unique IDs.

19. The system of claim 11, wherein the network information associated with a unique ID includes device identifiers and/or network addresses for at least two different networks.

20. The system of claim 11, wherein the device identifiers and/or network addresses for at least two different networks include two or more of LAN address, WLAN address, e-mail address, mobile subscriber ID (MSI) temporary mobile subscriber ID (TMSI), telephone number, and BlueTooth ID.
